(19) United States
(12) Patent Application Publication
(10) Pub. No.: US 2010/0054446 A1
(43) Pub. Date: Mar. 4, 2010

(54) VANITY TELEPHONE NUMBER TRANSLATION

(76) Inventor: James Richard Braun, Virginia Beach, VA (US)

Correspondence Address: ITALIA IP, 3500 WEST OLIVE AVE., SUITE 300, BURBANK, CA, 91505, US

(21) Appl. No.: 12/202,829

(22) Filed: Sep. 2, 2008

(51) Int. Cl. H04M 3/42

(52) U.S. Cl. 379/216.01

(57) ABSTRACT

Providing for electronic communications devices having QWERTY type keyboards a software based system which automatically translates alphabetical characters into numeric characters. Directly entered alphabetical characters are automatically converted to corresponding numeric characters. As an alternative to manually entered characters, in communications devices having a voice recognition feature, spoken signals are similarly converted. Automatic conversion proceeds only when the device is in a telephone mode of operation. Where fewer than ten characters are entered, the system may automatically add an area code to the number being dialed. If more than seven but fewer than ten characters are entered, some characters are eliminated.

### FIELD OF THE INVENTION

The present invention relates to a system which enables a telephone user to dial alphabetical characters into the keypad, such as so-called vanity telephone numbers. Software translates the alphabetical characters into corresponding numerical characters.

### BACKGROUND OF THE INVENTION

As part of a marketing strategy, businesses and organizations frequently utilize so-called “vanity numbers” as telephone numbers. Ordinarily, telephone numbers are presented as a series of numeric digits which are to be entered into the keypad of a telephone. Vanity numbers present recognizable text in place of some or all of the digits. This is frequently done within the context of toll free numbers. The text which has been selected imparts identity and recognition in the eye of the public. The text may comprise the name of the business or organization, or may comprise a term indicative of the nature or identity of the business or organization. Illustratively, a florist may adopt 1-800-FLOWERS as a phone number.

Although it becomes easy to remember a unique and distinctive vanity phone number, actually dialing such a number becomes awkward if the caller is using an electronic device having a typewriter style keyboard. A typewriter style keyboard has one key for each alphabetical character, as well as additional keys for punctuation and other symbols. One widely used keyboard has the letters Q, W, E, R, T, and Y, in addition to other letters. When dialing, the dialer must translate each letter into an equivalent numeral, then enter the derived numeral. This process is time consuming and objectionable.

There exists a need in the prior art to expedite dialing, or numerical character entry, of alphabetically presented telephone numbers.

### SUMMARY OF THE INVENTION

The present invention answers the above need by providing for electronic communications devices having typewriter type keyboards a software based system which automatically translates alphabetical characters into numeric characters. While the dialer enters directly what he or she thinks of as letters, the communications channel connected to the device having the keyboard operates as though numbers were entered.

In a further aspect of the invention, the communications device may have voice command capability, in which case the novel system converts spoken words or names into individual letters, and from letters to numeric characters. The call is dialed or placed seamlessly and invisibly to the caller.

It is an object of the invention to enable electronic communications devices having typewriter or QWERTY type keyboards to convert groups of letters to be automatically converted to corresponding numbers when placing a telephone call.

Another object of the invention is to enable automatic conversion of spoken words and names to electronically entered corresponding numeric characters.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic plan view of a communications device according to one aspect of the invention.

FIG. 2 is a diagrammatic plan view of a communications device according to another aspect of the invention.

FIG. 3 is a diagrammatic plan view of a communications device according to a further aspect of the invention.

### DETAILED DESCRIPTION

The present invention provides a system for enabling a person having an electronic communications device provided with a typewriter or QWERTY keyboard to enter alphabetical characters into the keyboard, and to have the communications device respond as though numeric characters had been entered. This is done within the context of dialing telephone numbers into the keyboard of the communications device. Applications for the novel system include convenient conversion of telephone numbers which have been presented to the caller in alphabetical form. So-called vanity numbers provide the most significant example. It would also be possible for a person to privately or on his or her own derive names or words which are equivalent to certain numeric characters when using the novel system. Illustratively, a person could convert the phone number of a family member, acquaintance, or the number of a place of work into a word or name which is easier to remember than the original ten or seven digit number.

Examples of devices which enable remote communications and which have a QWERTY style keypad include the products of Blackberry®, and the TREO®. Such devices may be improved by providing either as original software or firmware the programming which will be described hereinafter. Alternatively, such devices may have auxiliary cards connected thereto in any suitable way enabling communication so that they function as though the programming were internal or integral thereto.

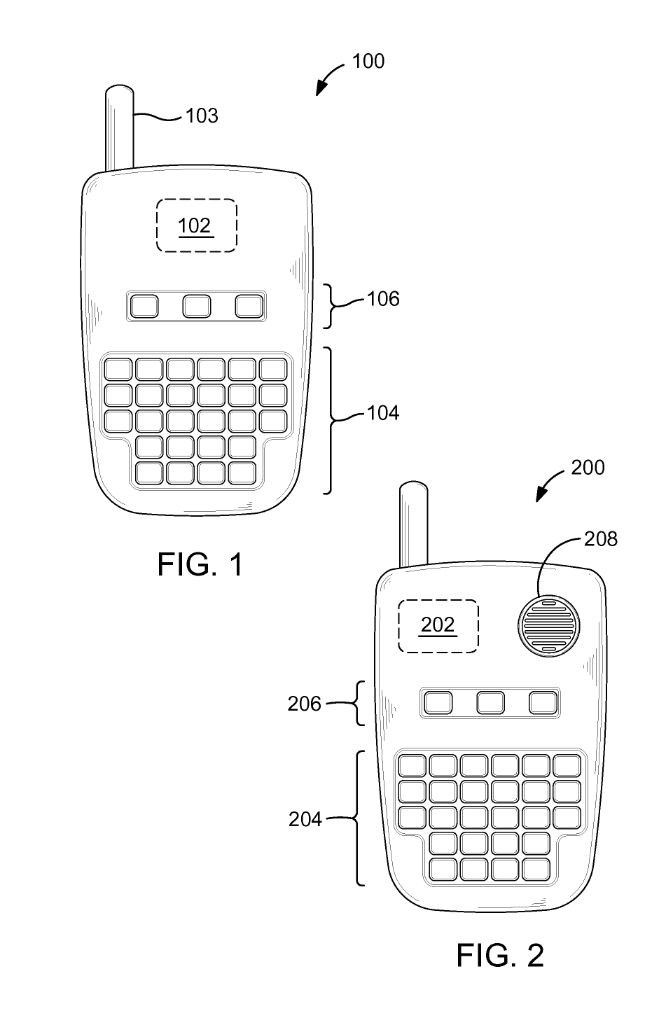

The present invention may be implemented in several ways. According to one aspect of the invention, and referring to FIG. 1, programming to implement automatic entry of numeric characters when dialing to initiate a telephone call may be integral to a communications device 100. The communications device 100 may comprise elements of known communications devices, including a preexisting memory 102, radio frequency communications elements (represented as an antenna 103, but which will be understood to include all necessary components for operation as described herein), a QWERTY type keyboard 104 having for example switches (not individually indicated) for accepting data entry corresponding to each letter of the Roman alphabet, and other operating switches 106. In addition, in the event the QWERTY type keyboard 104 shares keys with numbers and letters and symbols, a separate key (shift or control or function key) shall allow the phone to recognize that the input should utilize the letter versus the number versus the symbol.

Programming may be in the form for example of software which has been entered into the preexisting memory 102 of the communications device 100. The programming functions according to the following scheme.

Responsively to the usual commands which have been programmed into the communications device 100 for initiating and completing telephone calls which may be entered into the QWERTY type keyboard 104, the programming is automatically invoked to convert a telephone number input in alphabetical form to corresponding numeric digits. The corresponding digits are entered into the communications system as though they had originally been entered by the person initiating the telephone call.

The user types or manually enters into the QWERTY type keyboard 104 the alphabetical characters of the vanity number, and of course, any numeric characters which may be part of the vanity number. The novel conversion system is then operable to conduct necessary conversion from alphabetical characters to corresponding numeric signals. This conversion is automatic and is both seamless and invisible to the person making the telephone call. The telephone call may then be conducted and terminated in conventional manner.

The steps of initiating, conducting, and completing telephone calls will be referred to as placing the communications device into a telephone mode of operation. It will be appreciated that as electronic devices evolve, they can perform ever increasing functions. Therefore, while a significant aspect of an electronic device may comprise telephonic communications, it will be understood that electronic devices having additional functions will be encompassed by the term communications device. Accordingly, communications devices encompassed within any aspect of the invention may comprise ancillary features not strictly necessary to practice the invention, such as a display screen, a speaker, other data processing apparatus and systems, signal generating and emitting apparatus, and the like (none of these ancillary features is shown).

An example of a vanity telephone number and how it is handled by the novel programming will be presented. In this example, a caller may wish to telephone a florist business which provides the toll free vanity telephone number 1-800-FLOWERS. Obviously, the term “flowers” imparts identity to the telephone number so that a user both recognizes the nature of the entity being called and also may easily remember the telephone number.

The novel programming has a recognition feature which recognizes initiation of a telephone call just as the host communications device 100 recognizes initiation. Responsively to this recognition, the programming analyzes the input of alphabetical and numeric characters entered into the QWERTY keyboard 104 and applies the novel conversion in the following manner.

The number of characters entered into the QWERTY keyboard 104 is considered. If fewer than ten characters are entered, a local area code will be obtained for example by consulting a look-up table entered into the programming, and will be added to the string of entered characters. Some vanity telephone numbers have more than seven characters but fewer than ten characters. When more than seven characters but fewer than ten characters are entered, the number of characters is analyzed. The programming accepts seven characters and ignores the one or two extra characters. With the local area code automatically entered, a real or recognizable telephone number is generated and is dialed.

Analysis also considers alphabetical characters which have been entered. Conversion to numeric characters is then implemented. The usual scheme widely employed in telephone systems may be invoked. Illustratively, the letters A, B, and C are translated to the numeral 2; the letters D, E, and F are translated to the numeral 3; the letters G, H, and I are translated to the numeral 4; the letters J, K, and L are translated to the numeral 5; the letters M, N, and O are translated to the numeral 6; the letters P, Q, R, and S are translated to the numeral 7; the letters T, U, and V are translated to the numeral 8; and the letters W,X, Y, and Z are translated to the numeral 9.

Once the telephone number has been dialed, and for as long as the communications device 100 is in a telephone call mode of operation, the programming will continue to translate alphabetical keyboard entries into numeric digits. This feature enables secondary numbers to be dialed. For example, an initial phone call placed by the caller to a telephone directory service may be followed by a secondary phone call placed to the actual party to whom the caller wishes to speak. The second telephone number will then be connected using numeric characters if that is how the secondary number is presented, or will continue to use alphabetical to numeric conversion automatically if alphabetical characters are entered into the QWERTY keyboard 104. The latter situation may be the case where a telephone directory service makes vanity telephone numbers available.

According to still another aspect of the invention, and referring to FIG. 2, the novel conversion process may be utilized with a communications device 200 which has a preexisting memory 202, a keyboard 204 for entry of data, which keyboard 204 may or may not be of the QWERTY type, but also a voice recognition feature 208. The voice recognition feature 208 analyzes speech and converts speech into component letters, and will be understood to comprise all components necessary for operation as described herein. The letters may then be converted to corresponding numeric character signals, with a telephone number thus being entered and dialed. In the system of FIG. 2, manual entry of characters as practiced in the system of FIG. 1 is replaced by spoken signals, with the novel conversion system conducting necessary conversion from alphabetical characters to corresponding numeric signals. The telephone call is then completed conventionally.

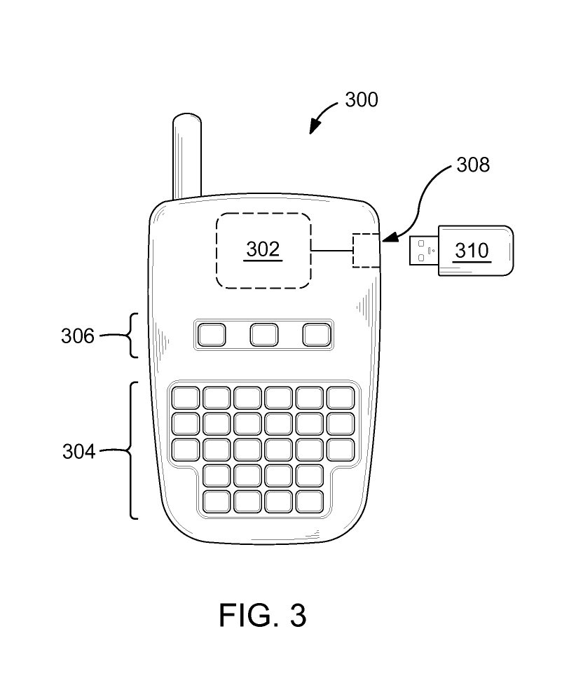

According to a further aspect of the invention, and as shown in FIG. 3, programming for a communications device 300 may be provided by an external source such as a programmed card 310 which communicates with the communications device 300 by an interruptible connection, such as by plugging into a communications port 308 with which the communications device 300 is equipped for the purpose of communicating between the preexisting memory 302 and external devices such as for example so-called smart cards. The external source of programming will be understood to include all circuitry and programming to control the communications device 300 as described herein. Circuitry will be understood to comprise the numbers and types of conductors, components, and connection scheme necessary to carry out the described functions. The communications device 300 may be of a type similar to the communications device 100 of FIG. 1, the communications device 300 illustratively having a QWERTY type keyboard 304 and other switches 306. Of course, the communications device 300 may be of the type using speech recognition, such as the communications device 200 of FIG. 2.

Any of the communications devices, such as the communications devices 100, 200, and 300, may be placed into a telephone mode of operation wherein the communications device will place a telephone call responsive to either manually or voice generated telephone number inputs. As stated before, these inputs may comprise numeric and/or alphabetical characters which enable a dialing procedure to be performed.

Regardless of the nature of how a telephone number is entered into the communications device, a conversion process is automatically implemented. The conversion process converts that portion of the telephone number which corresponds to alphabetical characters to corresponding numeric characters responsively to the communications device being placed in the telephone mode of operation.

Optional steps include analyzing the number of characters contained in the input in the course of automatic conversion. From this analysis, two features may be provided. One feature is that of adding an area code prior to the characters of the telephone number if analysis of the number of characters determines that the number of characters of the input is fewer than ten.

Analysis of the number of characters may also result in discarding of extraneous numbers. This comes into play when the number of characters of the telephone number exceeds seven but is less than ten. If eight characters are entered, then one character is eliminated to arrive at a recognizable seven digit number, which will then be assigned a local area code. If nine characters are entered, then two characters would be eliminated to arrive at the recognizable seven digit number. Similarly, if more than ten characters are entered, the additional characters would be eliminated.

The conversion process may continue as long as the communications device remains in the telephone mode of operation. The conversion process may be discontinued if the telephone mode of operation is terminated.

It will be appreciated that any of the communications devices used to practice the present invention, such as the communications devices 100, 200 and 300 may have programming be in the form of firmware contained within respective preexisting memories, such as the preexisting memories 102, 202, and 302.

Any of the communications devices used to practice the present invention, such as the communications devices 100, 200 and 300 may combine the features of manual data entry, such as by incorporating a QWERTY type keyboard such as the QWERTY type keyboard 104, with a voice or speech recognition feature such as the voice recognition feature 208.

A communications devices used to practice the present invention, such as the communications device 200, may have only a voice recognition feature such as the voice recognition feature 208, and may not have a QWERTY type keyboard such as the QWERTY type keyboard 204.

A further application of the invention is that of entering data in response to prompts from for example an automated telephone call directing feature of an organization which has been called. After the initial call has been completed, the caller may possibly be connected with the automated telephone call directing feature which solicits from the caller the identity of the specific party within the organization to whom the caller wishes to be connected. One frequently utilized form of such solicitation is a verbal prompt to dial the first three digits of the person's extension. The present invention may be invoked in this situation, especially when it is desired to utilize a voice or speech recognition feature.

I claim:

1. A method of dialing a telephone number by a communications device having a QWERTY type keyboard for accepting characters corresponding to telephone numbers to be dialed, and having a telephone mode of operation, the method comprising the steps of:
placing the communications device into a telephone mode of operation wherein the communications device will place a telephone call responsive to an input operable to initiate a telephone call;
entering characters corresponding to numeric characters which enable a dialing procedure to be performed; and
automatically implementing a conversion process of converting alphabetical characters entered to place a telephone call to corresponding numeric characters, responsively to the communications device being placed in the telephone mode of operation.

2. The method of claim 1, comprising the further steps of:
continuing the automatic conversion process while the communications device remains in the telephone mode of operation; and
discontinuing the automatic conversion process responsively to discontinuing of the telephone mode of operation.

3. The method of claim 1, further comprising the steps of:
analyzing the number of characters entered into the QWERTY type keyboard; and
adding an area code prior to the characters entered into the QWERTY type keyboard if the number of characters is fewer than ten.

4. The method of claim 1, comprising the further steps of analyzing the number of characters entered into the QWERTY type keyboard in the course of automatic conversion; and
discarding those characters exceeding in number seven characters but which are fewer than ten characters.

5. The method of claim 1, comprising the further steps of analyzing the number of characters entered into the QWERTY type keyboard in the course of automatic conversion; and
discarding those characters exceeding in number ten characters.

6. A method of dialing a telephone number by a communications device having a speech recognition and conversion feature, and having a telephone mode of operation, the method comprising the steps of:
placing the communications device into a telephone mode of operation wherein the communications device will place a telephone call;
entering speech signals to the speech recognition and conversion feature;
analyzing the speech signals to recognize alphabetical component elements; and
automatically implementing a conversion process of converting the alphabetical characters entered to place a telephone call to corresponding numeric characters, responsively to the communications device being placed in the telephone mode of operation.

7. The method of claim 6, comprising the further steps of:
continuing the automatic conversion process while the communications device remains in the telephone mode of operation; and
discontinuing the automatic conversion process responsively to discontinuing of the telephone mode of operation.

8. The method of claim 6, further comprising the steps of:
analyzing the number of characters spoken into the voice recognition and conversion feature; and
adding an area code prior to the characters entered into the voice recognition and conversion feature if the number of characters is fewer than ten.

9. The method of claim 6, comprising the further steps of analyzing the number of characters spoken into the voice recognition and conversion feature; and
discarding those characters exceeding in number seven characters but which are fewer than ten characters.

10. The method of claim 6, comprising the further steps of analyzing the number of characters entered into the QWERTY type keyboard in the course of automatic conversion; and
discarding those characters exceeding in number ten characters.
